(19) United States
(12) Patent Application Publication
(10) Pub. No.: US 2003/0078066 A1
(43) Pub. Date: Apr. 24, 2003

(54) System and method for approximating half duplex wireless dispatch system

(76) Inventors: Mark Maggenti, San Diego, CA (US); Eric C. Rosen, Solana Beach, CA (US)

Correspondence Address: Qualcomm Incorporated, Patents Department, 5775 Morehouse Drive, San Diego, CA, 92121-1714, US

(21) Appl. No.: 09/999,744

(22) Filed: Oct. 23, 2001

(51) Int. Cl. H04B 7/00

(52) U.S. Cl. 455/518; 455/517

(57) ABSTRACT

A wireless dispatch service in a full duplex wireless telephone system includes forward and reverse link pairs assigned to each voice communication device in a dispatch system. Depending on whether a device is talking or listening, one of the links for that device can be idled to conserve system energy, thereby approximating a half duplex system.

### FIELD OF THE INVENTION

The present invention relates generally to wireless dispatch systems wherein groups of users may speak to each other.

### BACKGROUND

In a wireless telephone communication system, dispatch services can be provided wherein many users can communicate over a wireless channel to connect to other wireless and wireline telephone systems in a private communication group. Communication over the wireless channel can be one of a variety of multiple access techniques. These multiple access techniques include time division multiple access (TDMA), frequency division multiple access (FDMA), and code division multiple access (CDMA). The CDMA technique has many advantages. An exemplary CDMA system is described in U.S. Pat. No. 4,901,307 issued Feb. 13, 1990 to K. Gilhousen et al., entitled “SPREAD SPECTRUM MULTIPLE ACCESS COMMUNICATION SYSTEM USING SATELLITE OR TERRESTRIAL REPEATERS,” assigned to the assignee of the present invention and incorporated herein by reference.

While typical wireless and wireline telephone service provides point-to-point service, dispatching services provide one-to-many service. Common applications of dispatch services include local police radio systems, taxicab dispatch systems, Federal Bureau of Intelligence and secret service operations, and general military communication systems.

The basic model of a wireless dispatch system consists of a broadcast net or group of users. Each user monitors a common broadcast forward link signal. If a user wishes to talk, the user requests permission to use a reverse link transmission channel by, e.g., pressing a push-to-talk (PTT) button on the user's wireless mobile station (MS), e.g., a wireless telephone. The talking user's voice is routed from the reverse link to telephony infrastructure and broadcast to other group members over the forward link. Ideally, the dispatch system allows landline and wireless access to the system.

In any case, wireless telephone voice systems are full duplex systems, that is, they are designed for normal (point to point) communication in which a user of a MS can both talk and listen at the same time. That is, a full duplex system is one which enables a user of an MS to send voice data to a base station over a reverse link, and simultaneously to receive voice data from the base station over a forward link.

As recognized by the present invention, however, dispatch systems, wherein one user talks and everyone else listens, are inherently half duplex in nature. There is generally no need for a forward link to the talking MS and no need for reverse links from the listening MS. Nonetheless, because existing wireless voice systems are configured as full duplex, both links are provided to each MS in a dispatch group. This wastes system energy, since certain information must be passed over each link in a pair even when the user of the MS is not actively exploiting that link. As but one example, a pilot channel of a forward link typically remains active with a duty cycle of one (1) while the MS is sending a talking user's voice data over the reverse link, to unnecessarily (in the context of dispatch operation) maintain continuous synchronization of the unused forward link. Also, vocoder and/or Radio Link Protocol (RLP) frames are transmitted over an unused link in a link pair. Having made the above-mentioned critical observations, the present invention provides the solutions set forth herein.

### SUMMARY OF THE INVENTION

For wireless mobile stations (MS) in a voice dispatch system that is implemented in a full duplex wireless communication system, either the forward or reverse link can be temporarily idled to conserve system energy, depending on whether the user of the MS is talking or listening. As intended herein, when a link is “substantially idled” while the associated MS is in a dispatch mode, the link carries less energy than it otherwise would carry in a normal communication (point to point) mode.

Accordingly, a method for providing a dispatch service to plural users of mobile stations in a full duplex wireless dispatch network that includes at least one base station (BTS), at least one talking mobile station (MS), at least one listening MS, and respective forward link and reverse link pairs between the BTS and each MS includes permitting the talking MS to transmit voice information in a dispatch service. The method also includes reducing or eliminating energy transmission in at least the reverse link that is associated with the listening MS or the forward link that is associated with the talking MS.

In a preferred embodiment, the reducing or eliminating act includes reducing at least one duty cycle, such as but not limited to reducing a pilot channel duty cycle to below one. Also, for the unused link in a pair (i.e., the reverse link for the listening MS and the forward link for the talking MS), which would otherwise carry vocoder or RLP frames, the vocoder and/or RLP frames that otherwise would be transmitted in the unused link can be reduced or eliminated.

In another aspect, a method for simulating half duplex operation in a wireless voice dispatch system having forward link and reverse link pairs established for each of plural mobile stations (MS) in a voice dispatch group includes idling the associated forward or reverse link for at least one MS, depending on whether the MS is a talking MS or a listening MS, respectively.

In another aspect, a wireless voice dispatch system includes at least one base station (BTS), a talking mobile station (MS), and at least one listening MS. Respective pairs of forward and reverse links can be established between each MS and the BTS with at least one link in at least one pair being substantially idled. The identity of the idled link in the pair depends on whether the associated MS is the talking MS or the listening MS.

In still another aspect, a wireless voice communication system includes at least one BTS, a talking wireless MS capable of entering a voice dispatch mode and a normal communication mode, and at least one listening wireless MS capable of entering a voice dispatch mode and a normal communication mode. A first full duplex link pair can be established between the BTS and the talking MS regardless of mode, and a second full duplex link pair can be established between the BTS and the listening MS regardless of mode. In accordance with the present invention, at least the first link pair carries a first amount of energy in the normal communication mode and a second amount of energy in the dispatch mode, with the second amount of energy being less than the first amount of energy.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system; and

FIG. 2 is a flow chart of the present logic.

### DETAILED DESCRIPTION OF THE PREFERRED EMBODIMENT

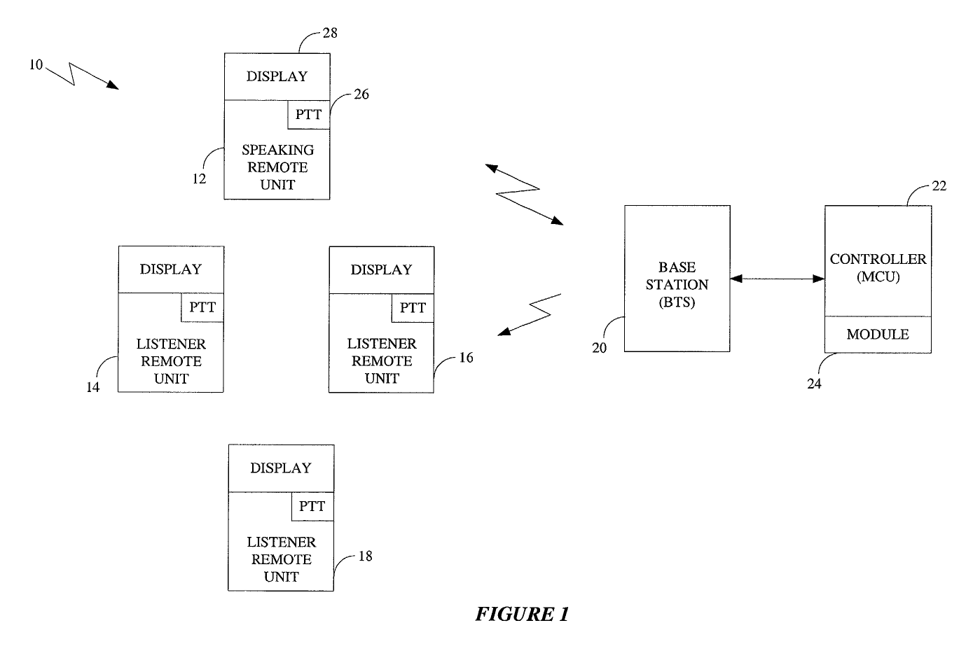

Referring initially to FIG. 1, a dispatch system is shown, generally designated 10. In the preferred embodiment, mobile stations (MS) 12, 14, 16, and 18 such as but not limited to wireless telephones may function both as dispatch units and as point-to-point telephones. For illustration, assume that the mobile station 12 has been granted use of the transmission channel of the system and thus is an active talker MS, and further assume that mobile stations 14, 16, and 18 are non-talking listeners.

FIG. 1 shows that a base station (BTS) 20 can provide respective forward link and reverse link pairs to each listening mobile stations 14, 16, and 18. Moreover, the base station 20 can provide a forward and reverse link pair to the talking mobile station 12.

FIG. 1 further shows that the base station 20 communicates with a media control unit (MCU) 22 having access to a logic module 24 that embodies at least portions of the logic discussed below. The MCU 22 can be implemented in the base station 20, or in a base station controller, or in a mobile switching center (MSC), or indeed in another wireless telephony infrastructure. Portions of the logic can be embodied in the MS of the present invention.

In one exemplary, non-limiting embodiment, the mobile stations 12, 14, 16, 18 are mobile telephones made by Kyocera, Samsung, or other manufacturer that use Code Division Multiple Access (CDMA) principles and CDMA over-the-air (OTA) communication air interface protocols such as defined in but not limited to IS-95A, IS-95B, UCDMA, IS-2000, and others. For instance, the wireless communication systems to which the present invention can apply, in amplification to those noted above, include Personal Communications Service (PCS) and cellular systems, such as Analog Advanced Mobile Phone System (AMPS) and the following digital systems: CDMA, Time Division Multiple Access (TDMA), and hybrid systems that use both TDMA and CDMA technologies. A CDMA cellular system is described in the Telecommunications Industry Association/Electronic Industries Association (TIA/EIA) Standard IS-95. Combined AMPS and CDMA systems are described in TIA/EIA Standard IS-98. Other communications systems are described in the International Mobile Telecommunications System 2000/Universal Mobile Telecommunications Systems (IMT-2000/UM), standards covering what are referred to as wideband CDMA (WCDMA), cdma2000 (such as cdma2000 1× or 3× standards, for example) or TD-SCDMA.

The present invention applies to any mobile stations 12, 14, 16, 18. In general, wireless communication devices to which the present invention applies may include but are not limited to a wireless handset or telephone, a cellular phone, and can be hand-held, or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice information, and may communicate with other devices using wired or wireless links. Further, commands might be used to cause modems or modules to work in a predetermined coordinated or associated manner to transfer voice information over multiple communication channels. Wireless communication devices are also sometimes referred to as user terminals, mobile stations, mobile units, subscriber units, remote units, mobile radios or radiotelephones, wireless units, or simply as “users” and “mobiles” in some communication systems.

In FIG. 1, the talking mobile station 12 has an established full duplex link with the base station 20. To become an active transmitter in the dispatch network, a mobile station sends a transmission request by, e.g., sending an access channel message requesting a traffic channel to the base station 20. In one non-limiting embodiment, this access channel message can be generated in response to a user appropriately manipulating a push-to-talk (PTT) button 26 on the mobile station 20.

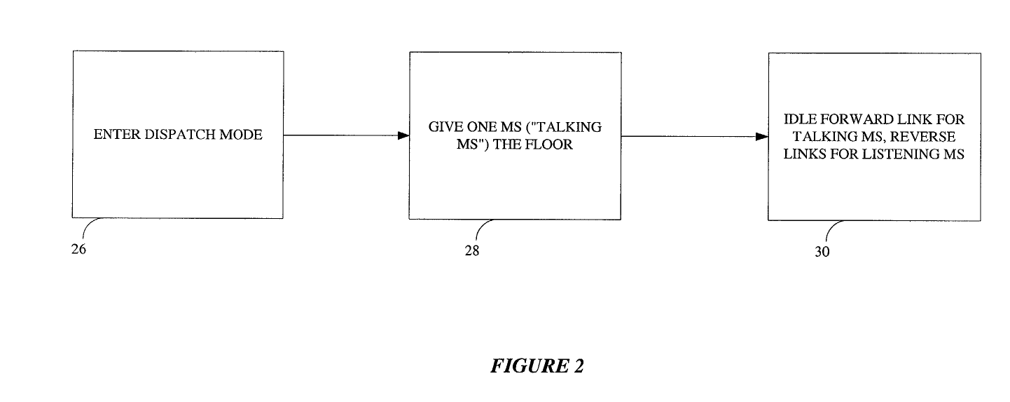

With the above architectural overview in mind, attention is now directed to FIG. 2. It is to be understood that the present logic is executed on the architecture shown in FIG. 1 in accordance with the flow charts discussed below. The flow charts herein illustrate the structure of the logic of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer, controller, processor, etc.) to perform a sequence of function steps corresponding to those shown.

In other words, the logic may be embodied by a computer program that is executed by processors within the above-described components as a series of computer- or control element-executable instructions. These instructions may reside, for example, in RAM or on a hard drive or optical drive, or the instructions may be stored on magnetic tape, electronic read-only memory, or other appropriate data storage device that can be dynamically changed or updated.

Now referring to the logic flow chart of FIG. 2, commencing at block 26 a group of MS enter a dispatch mode, wherein one-to-many communication is established. A pair of links (forward and reverse) remains established between each MS 12, 14, 16, 18 and the BTS 20. At block 28, one of the MS, e.g., the MS 12, is made a talking MS and is given the floor to transmit voice data over its reverse link to the BTS 20. Preferably, in the dispatch mode the communication uses voice over Internet Protocol (VOIP) principles known in the art within the infrastructure of the system. Accordingly, the voice data can be packetized into VOIP and sent through the infrastructure and transmitted back to the listening MS 14, 16, 18 over their respective forward links. One non-limiting way to make the MS 12 the talking MS is to receive and process a PTT signal from the MS 12.

Proceeding to block 30, at least the forward link for the talking MS 12 and/or one or more of the reverse links for the listening MS 14, 16, 18 are idled. By “idled” is meant that the link carries less energy than it otherwise would carry in a normal communication (point to point) mode. In any case, the particular link of a pair that is idled depends on whether the MS is talking or listening.

A link can be idled by reducing or eliminating energy transmission in the link. This can include but is not necessarily limited to reducing at least one duty cycle. By way of non-limiting example, the pilot channel duty cycle, which is typically one (1), can be reduced to below one half or even one quarter. Also, the transmission of vocoder and/or RLP frames in the unused link of a pair (i.e., the reverse links for the listening MS 14, 16, 18 and the forward link for the talking MS 12), which would otherwise be carried in point-to-point communication, can be reduced or eliminated. In any case, the present invention contemplates idling an unused link in a full duplex voice dispatch system by reducing the energy transmitted in the link relative to what the transmitted energy would be were the MS in a point-to-point mode. In this way, system efficiency is increased.

While the particular SYSTEM AND METHOD FOR APPROXIMATING HALF DUPLEX WIRELESS DISPATCH SYSTEM herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act.”

What is claimed is:

1. A method for providing a dispatch service to plural users of mobile stations in a full duplex wireless dispatch network, the network including at least one base station (BTS), at least one talking mobile station (MS), at least one listening MS, and respective link pairs each including a forward link and a reverse link between the BTS and at least one MS, the method comprising:
permitting the talking MS to transmit voice information in a dispatch service over the reverse link associated with the talking MS;
providing the voice information to the listening MS over the forward link associated with the listening MS; and
reducing or eliminating energy transmission in at least one of: the reverse link associated with the listening MS, and the forward link associated with the talking MS.

2. The method of claim 1, wherein the reducing or eliminating act includes reducing at least one duty cycle.

3. The method of claim 2, wherein the duty cycle is a pilot channel duty cycle.

4. The method of claim 3, wherein the pilot channel duty cycle is reduced to less than one.

5. The method of claim 4, wherein the pilot channel duty cycle is reduced to less than one half.

6. The method of claim 5, wherein the pilot channel duty cycle is reduced to less than one quarter.

7. The method of claim 1, wherein each of the links in a pair otherwise carry vocoder or RLP frames, and the reducing or eliminating act includes reducing or eliminating vocoder and/or RLP frames in at least one of: the reverse link associated with the listening MS, and the forward link associated with the talking MS.

8. A method for simulating half duplex operation in a wireless voice dispatch system having forward link and reverse link pairs established for each of plural mobile stations (MS) in a voice dispatch group, comprising:
for at least one MS in the group, idling the associated forward or reverse link, depending on whether the MS is a talking MS or a listening MS, respectively.

9. The method of claim 8, wherein the idling act is undertaken by at least reducing energy transmission in the link.

10. The method of claim 9, wherein the idling act is undertaken by eliminating energy transmission in the link.

11. The method of claim 9, wherein the reducing act includes reducing at least one duty cycle.

12. The method of claim 11, wherein the duty cycle is a pilot channel duty cycle.

13. The method of claim 12, wherein the pilot channel duty cycle is reduced to less than one.

14. The method of claim 13, wherein the pilot channel duty cycle is reduced to less than one half.

15. The method of claim 14, wherein the pilot channel duty cycle is reduced to less than one quarter.

16. A wireless voice dispatch system, comprising:
at least one base station (BTS);
at least one talking mobile station (MS); and
at least one listening MS, wherein respective pairs of forward and reverse links can be established between each MS and the BTS with at least one link in at least one pair being substantially idled, the identity of the link in the pair depending on whether the associated MS is the talking MS or the listening MS.

17. The system of claim 16, wherein a link that is substantially is characterized by a reduced duty cycle.

18. The system of claim 17, wherein the reduced duty cycle is a pilot channel duty cycle.

19. The system of claim 16, wherein a link that is substantially is characterized by the absence of vocoder and/or RLP frames.

20. A wireless voice communication system, comprising:
at least one BTS;
at least one talking wireless MS capable of entering a voice dispatch mode and a normal communication mode; and
at least one listening wireless MS capable of entering a voice dispatch mode and a normal communication mode, wherein
at least a first full duplex link pair can be established between the BTS and the talking MS regardless of mode, and at least a second full duplex link pair can be established between the BTS and the listening MS regardless of mode, wherein at least the first link pair carries a first amount of energy in the normal communication mode and a second amount of energy in the dispatch mode, the second amount of energy being less than the first amount of energy.

21. The system of claim 20, wherein at least the second link pair carries a first amount of energy in the normal communication mode and a second amount of energy in the dispatch mode, the second amount of energy being less than the first amount of energy.

22. The system of claim 20, wherein at least one duty cycle is reduced for at least one link pair in the dispatch mode relative to the duty cycle in the normal communication mode.

23. The system of claim 20, wherein at least a number of vocoder and/or RLP frames in a link is reduced for at least one link pair in the dispatch mode relative to the number of frames in the normal communication mode.

24. A system for providing a dispatch service to plural users of mobile stations in a full duplex wireless dispatch network, comprising:
at least one base station (BTS);
a talking mobile station (MS);
at least one listening MS;
respective forward link and reverse link pairs between the BTS and each MS;
means for permitting the talking MS to transmit voice information in a dispatch service; and
means for reducing or eliminating energy transmission in at least one of: the reverse link associated with the listening MS, and the forward link associated with the talking MS.

25. The system of claim 24, wherein the reducing or eliminating means includes means for reducing at least one duty cycle.

26. The system of claim 25, wherein the duty cycle is a pilot channel duty cycle.

27. The system of claim 26, wherein the means for reducing reduces the pilot channel duty cycle to less than one.

28. The system of claim 27, wherein the means for reducing reduces the pilot channel duty cycle to less than one half.

29. The system of claim 24, wherein each of the links in a pair otherwise carry vocoder or RLP frames, and the reducing or eliminating means includes means for reducing or eliminating vocoder and/or RLP frames in at least one of: the reverse link associated with the listening MS, and the forward link associated with the talking MS.

30. A logic component for simulating half duplex operation in a wireless voice dispatch system having forward link and reverse link pairs established for each of plural mobile stations (MS) in a voice dispatch group, comprising:
for at least one MS in the group, means for idling the associated forward or reverse link, depending on whether the MS is a talking MS or a listening MS, respectively.

31. The logic component of claim 30, wherein the idling means includes means for at least reducing energy transmission in the link.

32. The logic component of claim 30, wherein the idling means includes means for eliminating energy transmission in the link.

33. The logic component of claim 30, wherein the idling means includes means for reducing at least one duty cycle.

34. The logic component of claim 33, wherein the duty cycle is a pilot channel duty cycle, and the means for reducing reduces the pilot channel duty cycle to less than one.
